(19) United States
(12) Patent Application Publication
(10) Pub. No.: US 2017/0134968 A1
(43) Pub. Date: May 11, 2017

(54) Radio Network Nodes and Methods for Managing Information Relating to a Property of a First Radio Network Node

(71) Applicant: Telefonaktiebolaget LM Ericsson (publ), Stockholm (SE)

(72) Inventors: Per Sundblad, Linköping (SE); Stefan Alsterlid, Linköping (SE)

(21) Appl. No.: 15/320,924

(22) PCT Filed: Jul. 2, 2014
(86) PCT No.: PCT/SE2014/050840

§ 371 Date: Dec. 21, 2016

(51) Int. Cl. H04W 24/02; H04W 8/00; H04L 12/26; H04L 12/703; H04W 24/10

(52) U.S. Cl. CPC H04W 24/02; H04L 45/28; H04W 24/10; H04L 43/0817; H04W 8/005

(57) ABSTRACT

A first radio network node (120) and a method therein for managing information relating to a property of the first radio network node (120) as well as a second radio network node (121) and a method therein for managing information relating to a property of the first radio network node (120) are disclosed. The first radio network node (120) generates the information relating to the property based one or more criteria causing a change of the information relating to the property. The first radio network node (120) sends, to the second radio network node (121), the information relating to the property while using a dynamic routing protocol for distributing states of links in a transmission network (102), wherein the transmission network (102) is an underlay network to a radio access network (101). The radio access network (101) comprises the first radio network node (120) and the second radio network node (121). The second radio network node (121) operates based on the information relating to the property. Moreover, corresponding computer programs and carriers therefor are disclosed.

### TECHNICAL FIELD

Embodiments herein relate to wireless communication systems, such as telecommunication systems. A first radio network node and a method therein for managing information relating to a property of the first radio network node as well as a second radio network node and a method therein for managing information relating to a property of the first radio network node are disclosed. Moreover, corresponding computer programs and carriers therefor are disclosed.

### BACKGROUND

A telecommunication system generally comprises a radio access network and a core network, which manage different functions of the system and have different purposes.

The radio access network typically handles communication towards a user equipment, such as a cellular phone or the like. However, the radio access network also comprises various radio network nodes, such as radio base stations, radio network controllers or the like. Accordingly, the radio access network also handles communication between these radio network nodes.

The core network typically handles functions relating to subscriptions, network planning, admission control, and the like. One function of the core network is also to configure and control the radio access network. The core network may thus comprise core network nodes like, Mobility Management Entities (MME), Operation and Support Systems (OSS), Home Subscriber Systems (HSS) and the like. Accordingly, the core network handles communication between the core network nodes.

Both the communication between the core network nodes and the radio network nodes may be performed utilizing an underlying transmission network, i.e. the transmission network is an underlay network to both the radio access network and the core network. The transmission network may for example be an Internet Protocol (IP) network.

In a known telecommunication system of the above mentioned kind, a so called OSS-Radio and Core (RC) node handles configuration data to be distributed to the radio network node, such as an evolved-NodeB. The configuration data relates information of neighbour cell's, such as definition e.g. in terms of cell id, frequencies, channel bandwidth, carrier identity, and how the radio network node shall behave in network, such as auto neighbour relationship insertion, auto neighbour discovery. This OSS-RC node is a central node in the core network. Therefore, a problem may be that if the OSS-RC fails, the configuration of radio network nodes and distribution of configuration data therefore also fails. Moreover, in case of changes, e.g. interruptions, re-routing and the like, in the transmission network, it can be difficult for the OSS-RC node to collect as well as distribute information about the change from/to the radio network nodes. The OSS-RC node needs to detect changes in the network topology, e.g. transmission network, and act on these changes. This makes the distribution of configuration data slow and failure prone, i.e. when messages about changes in the transmission network cannot reach the OSS-RC node.

### SUMMARY

An object is thus to improve handling of the configuration data for the radio access network.

According to an aspect, the object is achieved by a method, performed by a first radio network node, for managing information relating to a property of the first radio network node. The first radio network node generates the information relating to the property based one or more criteria causing a change of the information relating to the property. The first radio network node sends, to a second radio network node, the information relating to the property while using a dynamic routing protocol for distributing states of links in a transmission network. The transmission network is an underlay network to a radio access network. The radio access network comprises the first radio network node and the second radio network node.

According to another aspect, the object is achieved by a first radio network node configured to manage information relating to a property of the first radio network node. The first radio network node is configured to generate the information relating to the property based one or more criteria causing a change of the information relating to the property. Moreover, the first radio network node is configured to send, to a second radio network node, the information relating to the property while using a dynamic routing protocol for distributing states of links in a transmission network. The transmission network is an underlay network to a radio access network. The radio access network comprises the first radio network node and the second radio network node.

According to a further aspect, the object is achieved by a method, performed by a second radio network node, for managing information relating to a property of a first radio network node, wherein a radio access network comprises the first radio network node and the second radio network node. The second radio network node receives, from the first radio network node, the information relating to the property while using a dynamic routing protocol for distributing states of links in a transmission network. The transmission network is an underlay network to the radio access network. The second radio network node operates based on the information relating to the property.

According to yet another aspect, the object is achieved by a second radio network node configured to manage information relating to a property of a first radio network node. A radio access network comprises the first radio network node and the second radio network node. The second radio network node is configured to receive, from the first radio network node, the information relating to the property while using a dynamic routing protocol for distributing states of links in a transmission network. The transmission network is an underlay network to the radio access network. Moreover, the second radio network node is configured to operate based on the information relating to the property.

According to embodiments herein, the dynamic routing protocol is used to distribute the property of the first radio network node to the second radio network node, The property may include the above mentioned configuration data. In this manner, a common database, including the properties of the radio network nodes of the radio access network, may be created. The common database may be realized in the form of replicated local databases in each radio network node. In some examples, the first and second radio network nodes may be located within a certain area. In that case, the local replicated database is limited to include information only pertaining to the certain area.

This means that the radio network nodes, such as the first and second radio network nodes, of the radio access network do not need to be specially configured to compensate for foreseeable changes in the transmission network. Instead, the radio network nodes distribute the information relating to a respective property between each other. From the distributed information, each radio network node is able to derive information needed for adaption to current conditions in the network, e.g. including the radio access network and/or the transmission network.

Advantageously, the radio access network is more robust than known radio access networks, which are dependent on the central OSS-RC node. The radio access network according to embodiments herein is independent of such central OSS-RC node. Therefore, the radio access network is more robust both in terms of retrieval of properties, such as configuration data, and provision of properties.

Moreover, coordination of configuration changes is simplified, since the radio node that causes the change sends information about its property to other radio network nodes.

### BRIEF DESCRIPTION OF THE DRAWINGS

The various aspects of embodiments disclosed herein, including particular features and advantages thereof, will be readily understood from the following detailed description and the accompanying drawings, in which:

FIG. 1 is a schematic overview of an exemplifying telecommunication system in which embodiments herein may be implemented,

FIG. 2 is a schematic, combined signaling scheme and flowchart illustrating embodiments of the methods when performed in the telecommunication system according to FIG. 1,

FIG. 3 is a flowchart illustrating embodiments of the method in the first radio network node,

FIG. 4 is a block diagram illustrating embodiments of the first radio network node,

FIG. 5 is a flowchart illustrating embodiments of the method in the second radio network node, and

FIG. 6 is a block diagram illustrating embodiments of the second radio network node.

### DETAILED DESCRIPTION

Throughout the following description similar reference numerals have been used to denote similar features, such as actions, steps, nodes, elements, units, modules, circuits, parts, items or the like, when applicable. In the Figures, features that appear in some embodiments are indicated by dashed lines.

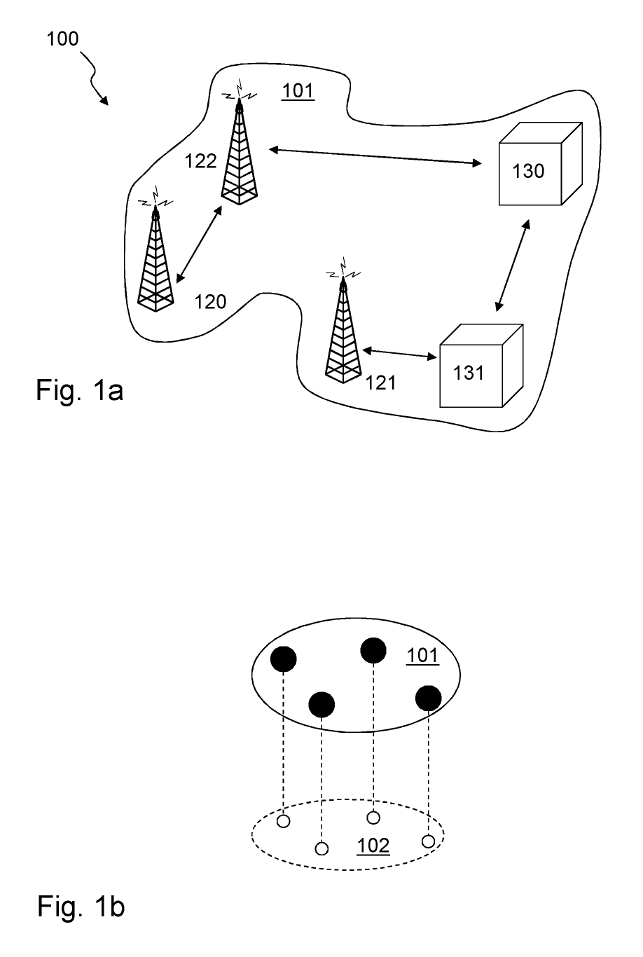

FIG. 1a depicts an exemplifying telecommunication system 100 in which embodiments herein may be implemented. In this example, the telecommunication system 100 is a Long Term Evolution (LTE) network. In other examples, the telecommunication network 100 may be any cellular or wireless communication system, such as a Wideband Code Division Multiple Access (WCDMA) network, High Speed Packet Access (HSPA), Wireless Fidelity (Wi-Fi), Global System for mobile communication (GSM) Enhanced Data Rates for GSM Evolution (EDGE) Radio Access Network (GERAN) or the like.

The telecommunication system 100 comprises a radio access network 101, such as an Evolved Universal Mobile Telecommunications System (UMTS) Terrestrial Radio Access Network (EUTRAN), UTRAN, GERAN or the like.

The radio access network 101 comprises a first radio network node 120, a second radio network node 121 and a third radio network node 122.

The term “radio network node” may refer to an evolved Node B (eNB), a donor eNode B, a relay node, a Node B, Base Station Controller (BSC), a Radio Network Controller (RNC), a Node B, a Radio Base Station (RBS), a control node controlling one or more Remote Radio Units (RRUs), an access point, a base station, a Base Station System (BSS) or the like.

Moreover, FIG. 1a shows a first router 130 and a second router 131 which inter-connects the first, second and third radio network nodes 120, 121, 122 in a transmission network 102 as illustrated in FIG. 1b.

Hence, FIG. 1b illustrates the radio access network 101 as an overlay network on top of the transmission network 102. The transmission network 102 may be an IP network or the like. The first, second and third radio network nodes 120, 121, 122 are shown as solid black bullets and network nodes of the transmission network 102 are shown as empty circles.

Before proceeding with descriptions of each action of the methods herein, it is here elaborated what is meant by the term “property” within this disclosure. Accordingly, as used herein the term “property”/“properties” has been used to refer to one or more of: at least one configuration parameter of the first radio network node 120, a state of the first radio network node 120, a condition relating the radio access network 101 in relation to the first radio network node 120 and the like. The property may therefore indicate configuration data for the radio access network as well as one or more states of the first radio network node.

The configuration data may include information about which features and functions are available in e.g. the first radio network node. As an example, this may mean that the configuration data includes information about which services, e.g. so called X2 interface access parameters for LTE, the first radio network node may provide.

The one or more states of the first radio network node 120 may relate to load of the first radio network node 120, e.g. number of served wireless devices (not shown), available bandwidth etc., radio network conditions as seen by the first radio network node 120, or the like. The radio network conditions may be indicated by channel quality indicators, signal-to-interference-and-noise ratio or the like.

As used herein, the term “wireless device” may refer to a user equipment, a machine-to-machine (M2M) device, a mobile phone, a cellular phone, a Personal Digital Assistant (PDA) equipped with radio communication capabilities, a smartphone, a laptop or personal computer (PC) equipped with an internal or external mobile broadband modem, a tablet PC with radio communication capabilities, a portable electronic radio communication device, a sensor device equipped with radio communication capabilities or the like. The sensor may be any kind of weather sensor, such as wind, temperature, air pressure, humidity etc. As further examples, the sensor may be a light sensor, an electronic or electric switch, a microphone, a loudspeaker, a camera sensor etc. The term “user” may indirectly refer to the wireless device. Hence, the wireless device may refer to any type of mobile terminal including mobile communication capability.

Furthermore, the expression “property” may relate to one or more of:
number of synchronization sources in the RAN and how to access them
synchronization information (how far from being in synch) to facilitate execution of other functions requiring nodes to be in synch,
connectivity information for interfaces (S1, X2 etc.),
interface (S1, X2 etc.) state, e.g. availability and characteristics,
Operation and Maintenance (O&M) configurations,
O&M commit over multiple network elements almost synchronized (sub second resolution),
MME connectivity information,
Security information, e.g. Open Certificates,
Key Performance Indicators, making it possible for other radio network nodes, such as the second and third radio network node 121, 122 to act on a malfunctioning neighbor node or a load distribution in the radio access network, and
when routing backhaul data through the RAN (if multiple ways exists)

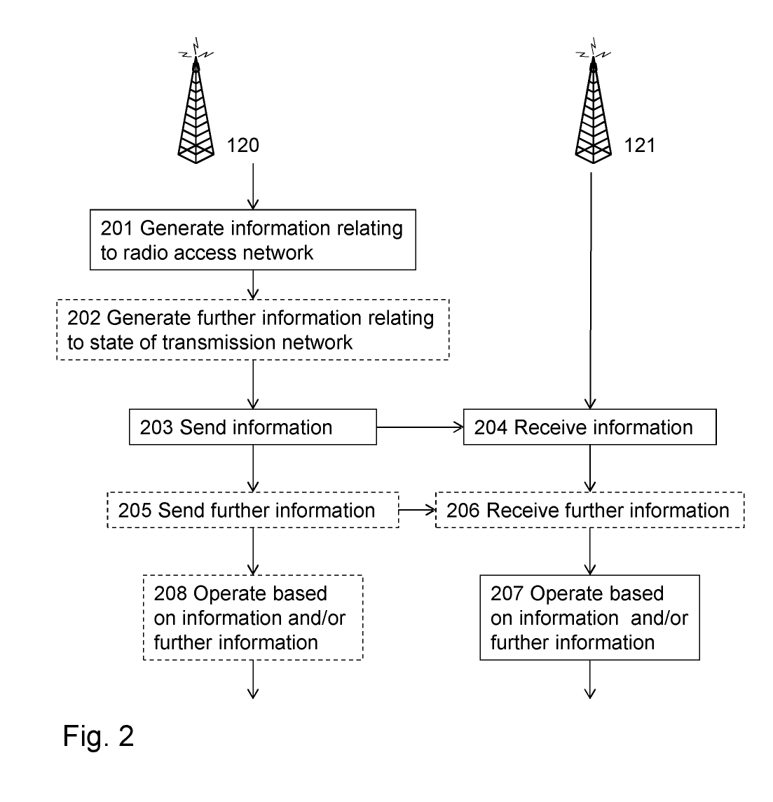

Further elaboration of the examples above will be provided after the description of FIG. 2.

When operating the methods disclosed herein, a so called state protocol is used to distribute information relating to the property. For example, a state protocol like Open Shortest Path First (OSPF), Intermediate System to Intermediate System (IS-IS), any other dynamic routing protocol or the like may be used. In order to limit the number of nodes to which the information relating to the property is distributed, tracking areas which are well-known in cellular systems, may be used. Hence, in case of OSPF the tracking areas may be mapped to routing areas. Each radio network node, such as the first, second and third radio network node 120, 121, 122, may be an owner and a source of its own information relating to the property (and re-issue information when changed). Other radio network nodes may hold a copy of the latest issued information from all other nodes, as done by OPSF's link state database, and issue it to its neighbours when requested, e.g. using OSPF.

A specific state protocol may be implemented to provide the features and functions as described herein. As an examples, such specific state protocol may be implemented be implemented as an application on top of OSPF, e.g. using so called OPAQUE message as described in Request For Comments (RFC) 5250 for OSPFv2, as a new message in IS-IS, or the like.

FIG. 2 illustrates an exemplifying method according to embodiments herein when performed in the telecommunication system 100 of FIG. 1. The first radio network node 120 performs a method for managing information relating to a property of the first radio network node 120. This may mean that the first radio network node 120 determines the information relating to the property. The second radio network node 121 performs a method for managing information relating to a property of a first radio network node 120. This may mean that the second radio network node 121 reacts in response to the information received by use of a dynamic routing protocol as explained below in more detail.

The following actions may be performed in any suitable order.

### Action 201

The first radio network node 120 generates the information relating to the property based one or more criteria. The one or more criteria cause a change of the information relating to the property. The one or more criteria may comprise one or more of:

radio conditions relating to the first radio network node 120;

a detection of presence of a third radio network node 122;

a detection of loss of a third radio network node 122; and

a detection of a failure in the first radio network node 120.

The information relating to the property may be generated in response to that one or more criteria is above, or below a threshold value for said one or more criteria.

As an example, the first radio network node 120 may generate the information relating to the property in response to that radio conditions relating to the first radio network node 120 are below, or above, a certain threshold value. The certain threshold value may relate to channel quality, radio bearers, bandwidth and the like.

When presence of the third radio network node 122 is detected, then the first radio network node 120 may generate information relating to the property, wherein the information relating to the property indicates that the third radio network node 122 is available, e.g. part of an area.

When loss of the third radio network node 122 is detected, then the first radio network node 120 may generate information relating to the property, wherein the information relating to the property indicates that the third radio network node 122 is not available, e.g. not part of an area.

When failure of the first radio network node 120 is detected, then the first radio network node 120 may generate information relating to the property, wherein the information relating to the property indicates that some function, or service, of the first radio network node 120 is not available. In this context, failure of the first radio network node 120 means a partial failure relating to one or more functions or services provided by the first radio network node 120.

### Action 202

The first radio network node 120 may generate further information relating to a state of the transmission network 102 in relation to the first radio network node 120.

As an example, the further information may specify whether there are, or have been, transmission disturbances; how long queues of the first radio network node 120 are; queues that may affect latency for transmission of packages; and accuracy of the clock used by the by the first radio network node 120. This action may be performed after action 203, but before action 205.

### Action 203

The first radio network node 120 sends, to the second radio network node 121, the information relating to the property. The information relating to the property is sent by use of a dynamic routing protocol, which is designed for distribution of states of links of a transmission network 102. In this manner, the information relating to the property in conveyed through the network to e.g. the second radio network node 121 and other nodes.

### Action 204

The second radio network node 121 receives, from the first radio network node 120, the information relating to the property while using a dynamic routing protocol for distributing states of links in a transmission network 102, wherein the transmission network 102 is an underlay network to the radio access network 101.

### Action 205

The first radio network node 120 may send, to the second radio network node 121, the further information while using the dynamic routing protocol.

### Action 206

The second radio network node 121 may receive, from the first radio network node 120, further information relating to a state of the transmission network 102 in relation to the first radio network node 120, wherein the operating 207 comprises operating based on the further information.

In some examples, the further information may be received from for example the third radio network node 122. This may be that action 206 may be repeated for any number of neighbouring radio network nodes.

### Action 207

The second radio network node 121 operates based on the information relating to the property. As an example, if the second radio network node 121 is informed, e.g. by means of the information about the property, about that a certain service, or function, is available in the first radio network node 120, then the second radio network node 121 may operate based on the information by using, e.g. exchanging information with, the certain service.

### Action 208

The first radio network node 120 may operate based on the information and/or the further information. This means that the first radio network node 120 may adapt its behaviour while taking the information and/or the further information into account.

At this stage, the first radio network node 120 may again perform action 201 and subsequent actions, e.g. repeatedly at regular or irregular time intervals. Similarly, as applicable, the second radio network node 121 may again perform action 204 and subsequent actions, e.g. repeatedly at regular or irregular time intervals.

Four example scenarios are described in the following; scenario 1—a node becomes reachable, scenario 2—a node becomes unreachable, scenario 3—a node changes a property and scenario 4—a node does not respond.

Scenario 1: Looking at FIG. 1, assume that the first radio network node 120 becomes available in the radio access network 101. In order for this to occur, the first radio network node 120 may first be discovered in the transmission network 102. Once this has occurred, the first radio network node 120 may start to distribute its properties in radio access network 101 through the dynamic routing protocol in transmission network 102. As an example of operation 201, the node traverses it configuration, its internal states and its performance data, e.g. measured properties both internal and external, and compiles the expected data set to publish. The publishing is an example of operation 203. This may be repeated as examples of operation 202 and 205. The second radio network node 121 receives this information as an example of operation 204 and possibly action 206 and updates its replicated local database. Thereafter, new actions to be executed in the second radio network node 121 may be triggered, e.g. due to that the replicated local database has changed. These actions are examples of operation 207.

Scenario 2: Looking at FIG. 1 again, assume that the first radio network node 120 becomes unreachable in the radio access network 101. In order for this to occur, the first radio network node 120 may first become unreachable in the transmission network 102. Once this has occurred, the second radio network node 121 in the transmission network 102 will receive a signal from the dynamic routing protocol indicating that the node is unreachable. The second radio network node 121 receives this information as an example of operation 204 and possibly 206 and updates its replicated local database. Thereafter, new actions to be executed in the second radio network node 121 may be triggered, e.g. due to that the replicated local database has changed. These actions are example of operation 207.

Scenario 3: Continuing with FIG. 1 as the base also for this scenario, assume that the first radio network node 120 and the second radio network node 121 are available in the radio access network 101. The first radio network node 120 changes a property as an example of operation 201. The first radio network node 120 publishes the information as an example of operation 203. The first radio network node 120 updates its replicated local database. Thereafter, new actions to be executed in the first radio network node 120 may be triggered, e.g. due to that the replicated local database has changed. These actions are example of operation 208. The second radio network node 121 receives information about the changed property, as an example of operation 204, and updates its local replicated database and it acts on the changed property, as an example of operation 207.

Scenario 4: A last example with FIG. 1 in mind, the second radio network node 120 does not receive expected information within a time frame, as an example of not receiving operation 204 from the second radio network node 121. As a consequence, the second radio network node 121 updates its replicated local database, e.g. by taking into account the lack of information from the first radio network node 120. Thereafter, new actions to be executed in the second radio network node 121 may be triggered, e.g. due to that the replicated local database has changed. These actions are examples of operation 207.

Implementing scenario 1, 2, 3 and 4 makes the network more robust, since each radio network node may adapt to the new environment as soon as data is available to radio network node.

In a first example, looking at FIG. 1, assume that the second radio network node 121 and third radio network node 122 are available in the 101 network and that second radio network node 121 provides a service, e.g. synchronization source, to third radio network node 122. At a certain time the first radio network node 120, which also is capable of providing the same source as third radio network node 122, becomes reachable, then scenario 1 occurs. Since third radio network node 122 is much closer to node 120, third radio network node 122 decides to utilize the service of node 120 instead of the service located at 121, due to that it is closer than the one currently used. Hence, the move of synchronization source is an example of the result of operation 207.

In a second example, looking at FIG. 1, assume that the first, second and third radio network nodes 120, 121 and 122 are available in the network, that second radio network node 121 and the first radio network node 120 provide the same service and that third radio network node 122 is utilizing the service at first radio network node 120. At a certain point in time first radio network node 120 becomes unreachable, then scenario 2 occurs and as a result of operation 207 third radio network node 122 switches its service utilization to second radio network node 121.

In a third example, looking at FIG. 1, assume that the nodes 120, 121 and 122 are available in the network, that first radio network node 120 provides a unique service, for example an interface for direct communication with first radio network node 120, and that third radio network node 122 is utilizing the service. At a certain point in time the service at first radio network node 120 becomes unavailable, then scenario 3 occurs, since the node is still reachable in the transmission network 102 and as a result of operation 207 third radio network node 122 stops utilizing this service (and stops trying to utilizing it as well).

In a forth example, looking at FIG. 1, assume the nodes 120, 121 and 122 are available in the network, that first radio network node 120 provides a unique service, for example an interface for direct communication with node when performing handovers to 120, and that third radio network node 122 is utilizing the service. At a certain point state updates from first radio network node 120 are not reaching third radio network node 122, then scenario 4 occurs, since the node is still reachable in the transmission network 102 and as a result of operation 207 third radio network node 122 stops utilizing first radio network node 120, since the node does not appear to provide any support in the 101 network.

In a fifth example, looking at FIG. 1, assume that the first, second and third radio network nodes 120, 121 and 122 are available in the network. At a certain point in time a new service at first radio network node 120 becomes available, then scenario 3 occurs, and the information of this service becomes available to third radio network node 122 as a consequence of operation 207. Third radio network node 122 may now start utilizing the new service, since information of how to utilize it is made available through operation 203 and possibly 205 in scenario 3.

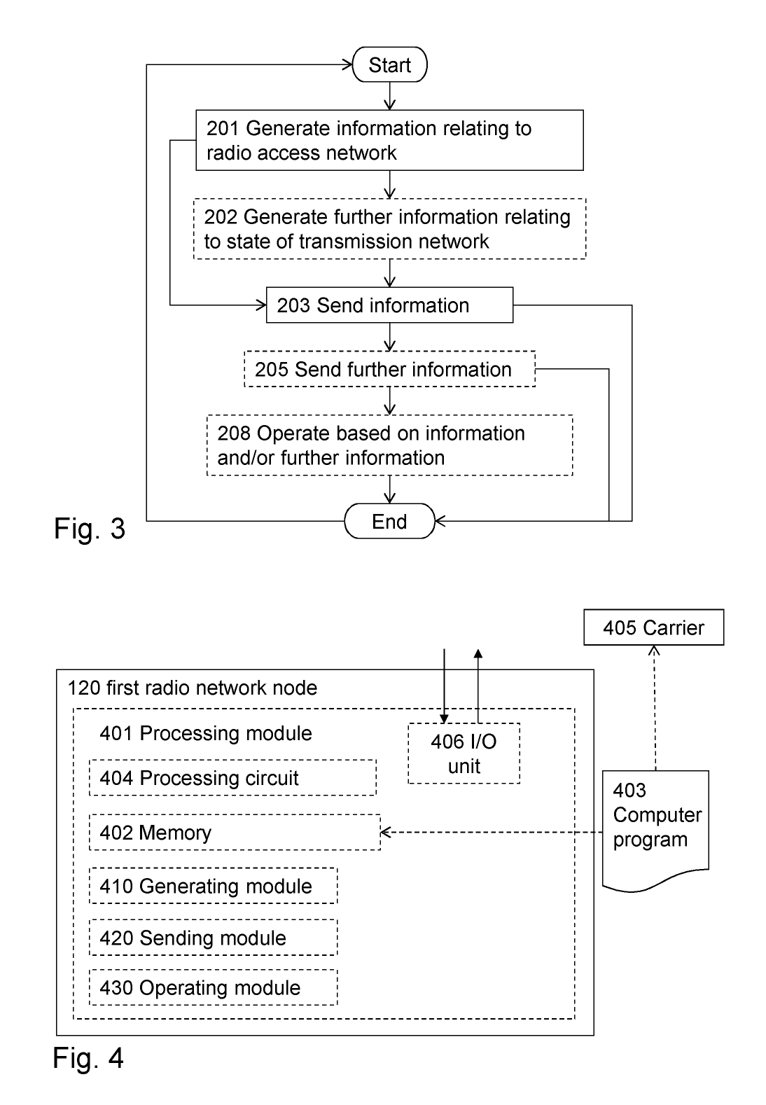

In FIG. 3, an exemplifying, schematic flowchart of embodiments of the method performed by the first radio network node 120 as illustrated in FIG. 2 above is shown. The first radio network node 120 thus performs a method for managing information relating to a property of the first radio network node 120. As mentioned, the same reference numerals have been reused to denote the same or similar action as in FIG. 2.

The property of the first radio network node 120 may comprise one or more of:

at least one configuration parameter of the first radio network node 120,

a state of the first radio network node 120,

a condition relating the radio access network 101 in relation to the first radio network node 120, and the like.

The following actions may be performed in any suitable order.

### Action 201

The first radio network node 120 generates the information relating to the property based one or more criteria causing a change of the information relating to the property.

The one or more criteria may comprise one or more of:

radio conditions relating to the first radio network node 120;

a detection of presence of a third radio network node 122;

a detection of loss of a third radio network node 122;

a detection of a failure in the first radio network node 120; and the like.

### Action 202

The first radio network node 120 may generate further information relating to a state of the transmission network 102 in relation to the first radio network node 120.

### Action 203

The first radio network node 120 sends, to a second radio network node 121, the information relating to the property while using a dynamic routing protocol for distributing states of links in a transmission network 102, wherein the transmission network 102 is an underlay network to a radio access network 101, wherein the radio access network 101 comprises the first radio network node 120 and the second radio network node 121.

### Action 205

The first radio network node 120 may send, to the second radio network node 121, the further information while using the dynamic routing protocol.

### Action 208

The first radio network node 120 may operate based on the information and/or the further information.

With reference to FIG. 4, a schematic block diagram of embodiments of the first radio network node 120 of FIG. 1 is shown. The first radio network node 120 configured to manage information relating to a property of the first radio network node 120.

As mentioned, the property of the first radio network node 120 may comprise one or more of:

at least one configuration parameter of the first radio network node 120,

a state of the first radio network node 120,

a condition relating the radio access network 101 in relation to the first radio network node 120, and the like.

The one or more criteria may comprise one or more of:
radio conditions relating to the first radio network node 120;
a detection of presence of a third radio network node 122;
a detection of loss of a third radio network node 122;
a detection of a failure in the first radio network node 120, and the like.

The first radio network node 120 may comprise a processing module 401, such as a means, one or more hardware modules and/or one or more software modules for performing the methods described herein.

The first radio network node 120 may further comprise a memory 402. The memory may comprise, such as contain or store, a computer program 403.

According to some embodiments herein, the processing module 401 comprises, e.g. ‘is embodied in the form of’ or ‘realized by’, a processing circuit 404 as an exemplifying hardware module. In these embodiments, the memory 402 may comprise the computer program 403, comprising computer readable code units executable by the processing circuit 404, whereby the first radio network node 120 is operative to perform the methods of FIG. 2 and/or FIG. 3.

In some other embodiments, the computer readable code units may cause the first radio network node 120 to perform the method according to FIG. 2 and/or 3 when the computer readable code units are executed by the first radio network node 120.

FIG. 4 further illustrates a carrier 405, comprising the computer program 403 as described directly above. The carrier 405 may be one of an electronic signal, an optical signal, a radio signal, and a computer readable medium.

In some embodiments, the processing module 601 comprises an Input/Output unit 406, which may be exemplified by a receiving module and/or a sending module as described below when applicable.

In further embodiments, the processing module 401 may comprise one or more of a generating module 410, a sending module 420 and an operating module 430 as exemplifying hardware modules. In other examples, one or more of the aforementioned exemplifying hardware modules may be implemented as one or more software modules.

Therefore, according to the various embodiments above, the first radio network node 120, the processing module 401 and/or the generating module 410 is operative to, e.g. is configured to, generate the information relating to the property based one or more criteria causing a change of the information relating to the property.

Furthermore, the first radio network node 120, the processing module 401 and/or the sending module 420 is operative to, e.g. is configured to, send, to a second radio network node 121, the information relating to the property while using a dynamic routing protocol for distributing states of links in a transmission network 102, wherein the transmission network 102 is an underlay network to a radio access network 101, wherein the radio access network 101 comprises the first radio network node 120 and the second radio network node 121.

Moreover, the first radio network node 120, the processing module 401 and/or the generating module 410, or another generating module not shown, may be operative to, e.g. may be configured to, generate further information relating to a state of the transmission network 102 in relation to the first radio network node 120.

The first radio network node 120, the processing module 401 and/or the sending module 420, or another sending module not shown, may be operative to, e.g. may be configured to send, to the second radio network node 121, the further information while using the dynamic routing protocol.

The first radio network node 120, the processing module 401 and/or the operating module 430 may be operative to, e.g. may be configured to operate based on the information and/or the further information.

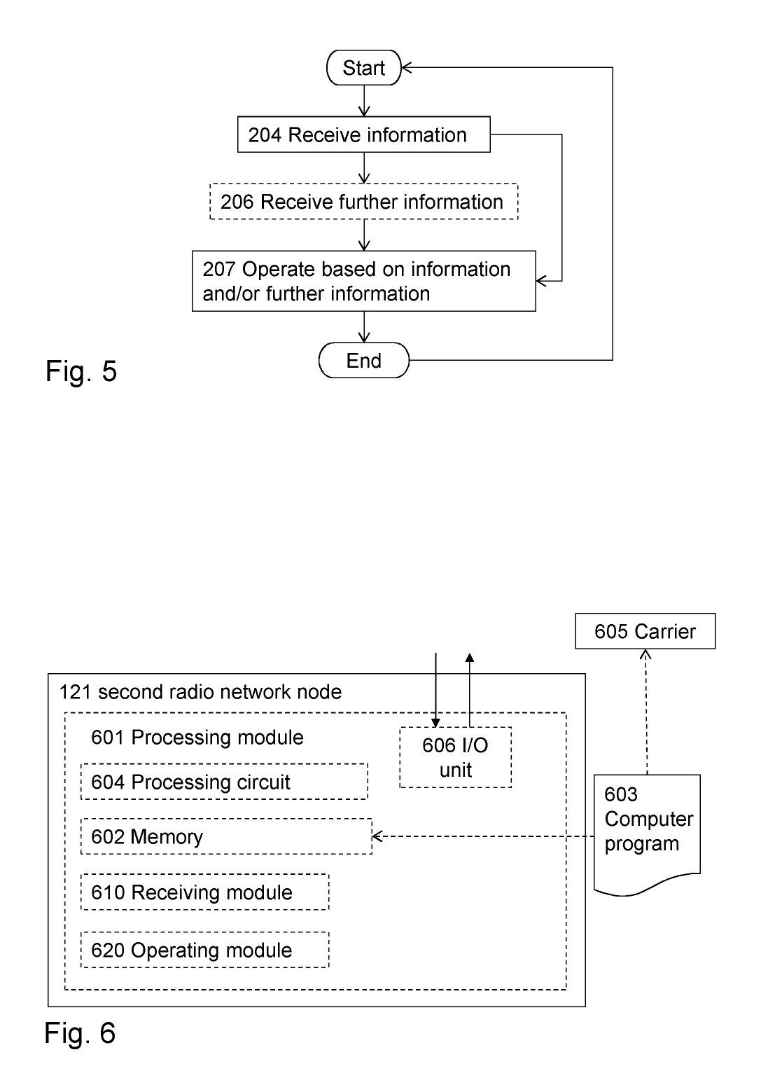

In FIG. 5, an exemplifying, schematic flowchart of embodiments of the method performed by the second radio network node 121 as illustrated in FIG. 2 above is shown. The second radio network node 121 thus performs a method for managing information relating to a property of the first radio network node 120. As mentioned, the same reference numerals have been reused to denote the same or similar action as in FIG. 2.

Again, the radio access network 101 comprises the first radio network node 120 and the second radio network node 121. The property of the first radio network node 120 may comprise one or more of:

at least one configuration parameter of the first radio network node 120,

a state of the first radio network node 120,

a condition relating the radio access network 101 in relation to the first radio network node 120, and the like.

The following actions may be performed in any suitable order.

### Action 204

The second radio network node 121 receives, from the first radio network node 120, the information relating to the property while using a dynamic routing protocol for distributing states of links in a transmission network 102, wherein the transmission network 102 is an underlay network to the radio access network 101; and

### Action 206

The second radio network node 121 may receive, from the first radio network node 120, further information relating to a state of the transmission network 102 in relation to the first radio network node 120, wherein the operating 207 comprises operating based on the further information.

### Action 207

The second radio network node 121 operates based on the information relating to the property.

The operating 207 may comprise using the at least one configuration parameter of the radio access network 101.

The use of the at least one configuration parameter may be performed while taking the state of the first radio network node 120 into account.

With reference to FIG. 6, a schematic block diagram of embodiments of the second radio network node 121 of FIG. 1 is shown. The second radio network node 121 is configured to manage information relating to a property of a first radio network node (120).

As mentioned, the radio access network (101) comprises the first radio network node (120) and the second radio network node (121). The property of the first radio network node 120 may comprise one or more of:

at least one configuration parameter of the first radio network node 120,

a state of the first radio network node 120,

a condition relating the radio access network 101 in relation to the first radio network node 120, and the like.

The second radio network node 121 may comprise a processing module 601, such as a means, one or more hardware modules and/or one or more software modules for performing the methods described herein.

The second radio network node 121 may further comprise a memory 602. The memory may comprise, such as contain or store, a computer program 603.

According to some embodiments herein, the processing module 601 comprises, e.g. ‘is embodied in the form of’ or ‘realized by’, a processing circuit 604 as an exemplifying hardware module. In these embodiments, the memory 602 may comprise the computer program 603, comprising computer readable code units executable by the processing circuit 604, whereby the second radio network node 121 is operative to perform the methods of FIG. 2 and/or FIG. 5.

In some other embodiments, the computer readable code units may cause the second radio network node 121 to perform the method according to FIG. 2 and/or 5 when the computer readable code units are executed by the second radio network node 121.

FIG. 6 further illustrates a carrier 605, comprising the computer program 603 as described directly above. The carrier 605 may be one of an electronic signal, an optical signal, a radio signal, and a computer readable medium.

In some embodiments, the processing module 601 comprises an Input/Output unit 606, which may be exemplified by a receiving module and/or a sending module as described below when applicable.

In further embodiments, the processing module 601 may comprise one or more of a receiving module 610 and an operating module 620 as exemplifying hardware modules. In other examples, one or more of the aforementioned exemplifying hardware modules may be implemented as one or more software modules.

Therefore, according to the embodiments above, the second radio network node 121, the processing module 601 and/or the receiving module 610 is operative to, e.g. configured to, receive, from the first radio network node (120), the information relating to the property while using a dynamic routing protocol for distributing states of links in a transmission network (102), wherein the transmission network (102) is an underlay network to the radio access network (101).

Furthermore, the second radio network node 121, the processing module 601 and/or the operating module 620 is operative to, e.g. configured to, operate based on the information relating to the property.

The second radio network node 121, the processing module 601 and/or the operating module 620 may be operative to, e.g. configured to, use the at least one configuration parameter of the radio access network (101).

The second radio network node 121, the processing module 601 and/or the operating module 620 may be operative to, e.g. configured to, use of the at least one configuration parameter while taking the state of the first radio network node (120) into account.

Moreover, the second radio network node 121, the processing module 601 and/or the receiving module 610, or another receiving module (not shown) may be operative to, e.g. configured to, receive, from the first radio network node (120), further information relating to a state of the transmission network (102) in relation to the first radio network node (120). The second radio network node 121, the processing module 601 and/or the operating module 620 may be operative to, e.g. configured to, operate based on the further information.

As used herein, the term “processing module” may in some examples refer to the processing circuit, such as a processing unit, a processor, an Application Specific integrated Circuit (ASIC), a Field-Programmable Gate Array (FPGA) or the like. The processing circuit or the like may comprise one or more processor kernels. In these examples, the processing module is thus embodied by a hardware module. In other examples, the processing module may be embodied by a software module. Any such module, be it a hardware, software or a combined hardware-software module, may be a determining means, estimating means, capturing means, associating means, comparing means, identification means, selecting means, receiving means, sending means or the like as disclosed herein. As an example, the expression “means” may be a module corresponding to the modules listed above in conjunction with the Figures.

As used herein, the expression “configured to” may mean that a processing circuit is configured to, or adapted to, by means of software configuration and/or hardware configuration, perform one or more of the actions described herein.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), etc.

As used herein, the term “computer readable code units” may be text of a computer program, parts of or an entire binary file representing a computer program in a compiled format or anything there between.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1-24. (canceled)

25. A method, performed by a first radio network node, for managing information relating to a property of the first radio network node, wherein the method comprises:
generating the information relating to the property based on one or more criteria causing a change of the information relating to the property; and
sending, to a second radio network node, the information relating to the property while using a dynamic routing protocol for distributing states of links in a transmission network, wherein the transmission network is an underlay network to a radio access network, wherein the radio access network comprises the first radio network node and the second radio network node.

26. The method according to claim 25, wherein the property of the first radio network node comprises one or more of:
at least one configuration parameter of the first radio network node;
a state of the first radio network node; and
a condition relating the radio access network in relation to the first radio network node.

27. The method according to claim 25, wherein the one or more criteria comprises one or more of:
radio conditions relating to the first radio network node;
a detection of presence of a third radio network node;
a detection of loss of a third radio network node; and
a detection of a failure in the first radio network node.

28. The method according to claim 25, wherein the method comprises:
generating further information relating to a state of the transmission network in relation to the first radio network node; and
sending, to the second radio network node, the further information while using the dynamic routing protocol.

29. The method according to claim 25, wherein the method comprises:
operating based on at least one of the information and the further information.

30. A method, performed by a second radio network node, for managing information relating to a property of a first radio network node, wherein a radio access network comprises the first radio network node and the second radio network node, wherein the method comprises:
receiving, from the first radio network node, the information relating to the property while using a dynamic routing protocol for distributing states of links in a transmission network, wherein the transmission network is an underlay network to the radio access network; and
operating based on the information relating to the property.

31. The method according to claim 30, wherein the property of the first radio network node comprises one or more of:
at least one configuration parameter of the first radio network node;
a state of the first radio network node; and
a condition relating the radio access network in relation to the first radio network node.

32. The method according to claim 31, wherein the operating comprises using the at least one configuration parameter of the radio access network.

33. The method according to claim 32, wherein the use of the at least one configuration parameter is performed while taking the state of the first radio network node into account.

34. The method according to claim 30, wherein the method comprises:
receiving, from the first radio network node, further information relating to a state of the transmission network in relation to the first radio network node, wherein the operating comprises operating based on the further information.

35. A first radio network node configured to manage information relating to a property of the first radio network node, wherein the first radio network node comprises:
communication circuitry configured for communication directly or indirectly with a second radio network node; and
processing circuitry operatively associated with the communication circuitry and configured to:
generate the information relating to the property based on one or more criteria causing a change of the information relating to the property; and
send, to the second radio network node, the information relating to the property while using a dynamic routing protocol for distributing states of links in a transmission network, wherein the transmission network is an underlay network to a radio access network, wherein the radio access network comprises the first radio network node and the second radio network node.

36. The first radio network node according to claim 35, wherein the property of the first radio network node comprises one or more of:
at least one configuration parameter of the first radio network node;
a state of the first radio network node; and
a condition relating the radio access network in relation to the first radio network node.

37. The first radio network node according to claim 35, wherein the one or more criteria comprises one or more of:
radio conditions relating to the first radio network node;
a detection of presence of a third radio network node;
a detection of loss of a third radio network node; and
a detection of a failure in the first radio network node.

38. The first radio network node according to claim 35, wherein the processing circuitry is configured to:
generate further information relating to a state of the transmission network in relation to the first radio network node; and
send, to the second radio network node, the further information while using the dynamic routing protocol.

39. The first radio network node according to claim 35, wherein the processing circuitry is configured to operate based on at least one of the information and the further information.

40. A second radio network node configured to manage information relating to a property of a first radio network node, wherein a radio access network comprises the first radio network node and the second radio network node, wherein the second radio network node comprises:
communication circuitry configured for communicating directly or indirectly with the first radio network node; and
processing circuitry operatively associated with the communication circuitry and configured to:
receive, from the first radio network node, the information relating to the property while using a dynamic routing protocol for distributing states of links in a transmission network, wherein the transmission network is an underlay network to the radio access network; and
operate based on the information relating to the property.

41. The second radio network node according to claim 40, wherein the property of the first radio network node comprises one or more of:
at least one configuration parameter of the first radio network node;
a state of the first radio network node; and
a condition relating the radio access network in relation to the first radio network node.

42. The second radio network node according to claim 41, wherein the processing circuitry is configured to use the at least one configuration parameter of the radio access network.

43. The second radio network node according to claim 42, wherein the processing circuitry is configured to use the at least one configuration parameter while taking the state of the first radio network node into account.

44. The second radio network node according to claim 40, wherein the processing circuitry is configured to:
receive, from the first radio network node, further information relating to a state of the transmission network in relation to the first radio network node, wherein the second radio network node is configured to operate based on the further information.

45. A non-transitory computer readable storage medium storing a computer program for managing information relating to a property of a first radio network node, the computer program comprising computer readable code that, when executed on a processing circuit of the first radio network node, causes the first radio network node to:
generate the information relating to the property based on one or more criteria causing a change of the information relating to the property; and
send, to a second radio network node, the information relating to the property while using a dynamic routing protocol for distributing states of links in a transmission network, wherein the transmission network is an underlay network to a radio access network, wherein the radio access network comprises the first radio network node and the second radio network node.

46. A non-transitory computer readable storage medium storing a computer program for managing information relating to a property of a first radio network node, wherein a radio access network comprises the first radio network node and a second radio network node, the computer program comprising computer readable code that, when executed on a processing circuit of the second radio network node, causes the second radio network node to:
receive, from the first radio network node, the information relating to the property while using a dynamic routing protocol for distributing states of links in a transmission network, wherein the transmission network is an underlay network to the radio access network; and
operate based on the information relating to the property.
